(19) United States
(12) Patent Application Publication
(10) Pub. No.: US 2010/0276165 A1
(43) Pub. Date: Nov. 4, 2010

(54) Method of Improving Fuel Tank Safety

(75) Inventors: David M. Hobson, Derbyshire (GB); Alex F. Psaila, Westerham (GB)

Correspondence Address: THE LUBRIZOL CORPORATION;ATTN: DOCKET CLERK, PATENT DEPT., 29400 LAKELAND BLVD., WICKLIFFE, OH, 44092, US

(73) Assignee: The Lubrizol Corporation, Wickliffe, OH (US)

(21) Appl. No.: 12/739,171

(22) PCT Filed: Oct. 30, 2008
(86) PCT No.: PCT/US08/81729

§ 371 Date: Jul. 27, 2010

Related U.S. Application Data
(60) Provisional application No. 60/984,755, filed on Nov. 2, 2007.

(51) Int. Cl. A62C 3/07; B60K 15/03

(52) U.S. Cl. 169/45; 220/88.1

(57) ABSTRACT

The invention relates to a method for improving the safety of a fuel tank by (1) supplying to the fuel tank a fuel and a flame suppressant, wherein the fuel tank contains two or more compartments, at least one compartment containing fuel, and at least one compartment containing flame suppressant, and wherein the compartment containing flame suppressant is either: (i) located to the exterior of the fuel tank, (ii) located within the interior of the fuel tank, or (iii) mixtures thereof; (2) rupturing the fuel tank and the compartment containing flame suppressant; and (3) mixing or otherwise contacting the flame suppressant with fuel from the fuel tank.

### FIELD OF INVENTION

The invention relates to a method for improving the safety of a fuel tank. The invention provides a fuel tank with flame suppressant.

### BACKGROUND OF THE INVENTION

For a fire to start, survive and spread three things are required: heat, oxygen and a fuel. The fuel may be solid, liquid or gas. However, combustion only occurs when the fuel is in the form of a vapour. Once fuel vapour has formed and there is sufficient oxygen and heat, the risk of fire or explosion increases significantly. Flame extinguishers (or suppressants) work either by cooling, or by forming a protective layer (e.g. a foam) over the combustible fuel and thus cutting off the oxygen supply, or by curtailing the free radical flame propagation steps of the chain reaction either by dilution of the radicals with an inert gas or by supplying radicals such a halogen radicals which preferentially react with these radical in chain termination reactions.

The risks of fire or explosion are a known hazard in fuel storage areas or vehicles. In particular, the risks may be considered significant if there is an accident causing a projectile to penetrate the fuel tank or storage container. The projectile may be debris from an accident, a weapon, or some other object. In addition, accidents may cause a fuel tank or fuel container to rupture resulting in fuel spillage. Upon spillage the risks of fire or explosion increase due to increased availability of fuel, heat and oxygen. Rupturing of fuel tanks is believed to be a common reason for fires or explosions.

Various attempts have been made to minimise fire or explosions in fuel tanks or storage facilities. The attempts are summarised in the references cited below.

A variety of references disclose fuel tanks with flame suppressants located to the exterior of the fuel tank. The flame suppressants include water, powders and inert gases. These references include French Patent 635 827 A; British Patents 1,380,420; 1,445,832; 1,453,836; 1,454,492; 1,454,493; 1,496,652; 1,547,568; and U.S. Pat. Nos. 2,911,049; 3,698,597; 3,930,541; 4,121,666; 4,132,271; 4,215,752; 4,251,579; and 4,262,749.

European Patent Application 1 746 380 A discloses an emergency evacuation device for a vehicle fuel tank including a one-way valve located in the lower part of the fuel tank and ensuring evacuation of the fuel by gravity in the case of excessive interior pressure in the fuel tank. Evacuation of fuel is a safety device for vehicles (in particular military vehicles) minimising the risk of fire in the case of damage to the fuel tank due to penetration by a projectile.

U.S. Pat. No. 4,121,666 discloses an upright fuel tank, an improved hollow panel containing pressurized fire-suppressant, the panel being located so that the suppressant sprays through an opening formed in the panel by an enemy projectile after its passage through the fuel tank. The hollow panel is reinforced against premature bursting forces by the provision of internal partitions running parallel to the major axis of the panel; the major walls of the panel are curved or bowed parallel to the minor axis of the panel to further reinforce the panel against premature bursting.

JP 9188145 A discloses a means of preventing a fire accident from occurring due to fuel flowing out of a vehicle fuel tank broken by an impact from the outside or the like and conduct prompt fire extinguishing work even if it is ignited. Disclosed is a fuel tank with an outer layer. The space between the outer layer and the fuel tank contains fire extinguisher. The extinguisher includes powders or inert gases.

### SUMMARY OF THE INVENTION

The inventors of the present invention have unexpectedly discovered that methods disclosed herein are capable of improving safety of fuel tanks or fuel storage containers. In particular the present invention has unexpectedly discovered that it is possible to minimise vehicle fires or explosions resulting from rupture of fuel tank in an accident or penetration by a projectile.

In one embodiment the invention provides a method for improving the safety of a fuel tank comprising:
(1) supplying to the fuel tank a fuel and a flame suppressant, wherein the fuel tank contains two or more compartments, at least one compartment containing (that is to say, at least one compartment comprising) fuel, and at least one compartment containing a flame suppressant, and wherein the compartment containing flame suppressant (that is to say, comprising at least one flame suppressant) is either:
   (i) located to the exterior of the fuel tank,
   (ii) located within the interior of the fuel tank, or
   (iii) mixtures thereof;
(2) rupturing the fuel tank and the compartment containing flame suppressant; and
(3) mixing or otherwise contacting the flame suppressant with fuel from the fuel tank.

Steps (2) and (3) above may also be defined such that wherein upon rupturing the fuel tank and the compartment containing flame suppressant the flame suppressant is mixed or otherwise contacted with fuel from the fuel tank.

In one embodiment the fuel tank contains two or more compartments, at least one compartment containing fuel, and at least one compartment containing an aqueous fluid which acts as a flame suppressant. Typically this type of flame suppressant comprises surfactants, foaming agents or other suppressant chemicals incorporated either in solution or in a dispersed state, and wherein the compartment containing flame suppressant is located to the exterior of the fuel tank. A flame suppressant of this type may have an additional advantage of, in the event that the fuel tank inadvertently leaks resulting in mixing of flame suppressant and fuel, the vehicle remains operational.

In one embodiment the invention provides a method for improving the safety of a fuel tank comprising:
(1) supplying to the fuel tank a fuel and a flame suppressant, wherein the fuel tank contains two or more compartments, at least one compartment containing fuel, and at least one compartment containing an aqueous system containing surfactant and other chemicals; and wherein the compartment containing flame suppressant is either:
   (i) located to the exterior of the fuel tank,
   (ii) located within the interior of the fuel tank, or
   (iii) mixtures thereof;
(2) rupturing the fuel tank and the compartment containing flame suppressant; and
(3) mixing or otherwise contacting the flame suppressant with fuel from the fuel tank.

The aqueous system containing surfactant and other chemicals which (1) may comprise at least 5%, or at least 10% by volume of the total fluid volume in the tank; (2) may be capable of rapidly lowering the surface tension of the oil/water interface which forms when the fluids come into contact, and consequently accelerating the rapid spread of the aqueous phase on and through the organic hydrocarbon fuel, possible forming a micro or macro emulsion, which may be a w/o or o/w or a multiple o/w/o or w/o/w emulsion.

In one embodiment the invention provides a method for improving the safety of a fuel tank comprising:
(1) supplying to the fuel tank a fuel and a flame suppressant, wherein the fuel tank contains three or more compartments, at least one compartment containing fuel, and at least two compartments comprising flame suppressant, wherein at least one compartment containing flame suppressant is located to the exterior of the fuel tank, and wherein at least one compartment containing flame suppressant is located within the interior of the fuel tank. The flame suppressants in the two compartments may be connected or isolated from one another in which case two different suppressants may be employed (for example an aqueous surfactant mixture in the exterior tank containing chemicals for lowering the interfacial tension and foaming chemicals, and a compressed CO₂ tank in the interior tank;
(2) rupturing the fuel tank and the compartment containing flame suppressant; and
(3) mixing or otherwise contacting the flame suppressant with fuel from the fuel tank.

In one embodiment the invention provides a method for improving the safety of a fuel tank comprising:
(1) supplying to the fuel tank a fuel and a flame suppressant, wherein the fuel tank contains two or more compartments, at least one compartment containing fuel, and at least one compartment containing an aqueous emulsification suppressant, and wherein the compartment containing flame suppressant is located within the interior of the fuel tank;
(2) rupturing the fuel tank and the compartment containing flame suppressant; and
(3) mixing or otherwise contacting the flame suppressant with fuel from the fuel tank.

In one embodiment the invention provides a method for improving the safety of a fuel tank comprising:
(1) supplying to the fuel tank a fuel and a flame suppressant, wherein the fuel tank contains two or more compartments, at least one compartment containing fuel, and at least one compartment containing an aqueous emulsification suppressant, and wherein the compartment containing flame suppressant is located to the exterior of the fuel tank;
(2) rupturing the fuel tank and the compartment containing flame suppressant; and
(3) mixing or otherwise contacting the flame suppressant with fuel from the fuel tank.

The embodiments described herein containing two or more tanks may or may not have the tanks interlinked.

In one embodiment at least one of the compartments described herein contains a flame suppressant which is an aqueous fluid containing surfactants and foaming agents.

### DETAILED DESCRIPTION OF THE INVENTION

The present invention provides a method as disclosed herein above.

As used herein the term “flame suppressant” includes a flame extinguisher.

As used herein the term “fuel tank” also includes a fuel cell or a fuel storage container. The fuel cell term is commonly used as a synonym of fuel tank in a NASCAR racing car.

### Fuel Tank

In one embodiment the compartment containing flame suppressant is located to the exterior of the fuel tank.

In one embodiment the compartment containing flame suppressant surrounds the exterior of the fuel tank.

In one embodiment the fuel tank is serviced by two or more compartments containing flame suppressant. For example the fuel tank may be serviced by (i) a compartment containing flame suppressant located on the exterior surrounding the fuel tank, and (ii) a compartment containing flame suppressant located within the interior of the fuel tank.

In one embodiment the compartment containing flame suppressant and fuel tank are separate units connected with a pipeline with a one-way valve allowing flame suppressant to flow into the fuel tank.

When the compartment containing flame suppressant is located to the exterior of the fuel tank, the flame suppressant is typically an aqueous system containing surfactants and foaming chemicals.

In one embodiment the compartment containing flame suppressant is located within the interior of the fuel tank as either a free-floating compartment or as a fixed unit. A compartment located within the interior of the fuel tank typically is sufficiently fragile to break on impact. However, the compartment typically will be capable of avoiding accidental rupture resulting in unnecessary leakage of flame suppressant into the fuel. Unnecessary leakage may result in contamination of fuel tank fuel, which may or may not reduce the ability to use the fuel. Examples of a suitable flame suppressant compartment may include burstable devices (such as discs, balls, spheres, cylinders, balloons, coils or piping), or membranes.

### Flame Suppressant

As used herein the term flame retardant includes explosion extinguishers.

Step (3) of the method specifies that the fuel and flame suppressant either mix or otherwise come into contact. Coming into contact typically encompasses forming a layer between the fuel and oxygen from the air. The layer may be a aqueous foam, a low surface tension aqueous layer, powder, gel, or inert gas.

In one embodiment at least one of the compartments containing the flame suppressant employ a powder. The powder typically forms a blanket capable of preventing fire or explosion.

Examples of inert gas include carbon dioxide, argon or a gas stored in liquid form under pressure e.g, water vapour.

In one embodiment a water-in-oil emulsion described herein below contains a HALON and/or a diesel fuel in the emulsion oil phase.

The flame suppressant may also be derived from HALON extinguishers or non-HALON extinguishers.

In one embodiment the HALON class of fire extinguishers includes HALON 104 (carbon tetrachloride, CCl₄), HALON 1301, (CF₃ Br) or HALON 1211 (CF₂ BrCl). It is believed that these materials thermally decompose in a fire or flame to produce the bromine free-radical which disrupts the chain reactions in the burning process.

The role of the bromine free-radical, produced by the thermal decomposition of a HALON, is believed to disrupt the chain reactions by reacting faster with other radicals which take part in the propagation steps of the flame reaction. The reaction with halgen free-radicals is a termination step. Possible reaction mechanisms include the hydrogen free radicals combining with the bromine free-radicals to form HBr which then may react with the hydroxide radical to produce water (H₂O), and a bromine radical thereby interrupting the combustion process chain reaction and regenerating the bromine radical. Bromine containing compounds, particularly the gaseous or low boiling point HALONs, are very effective fire extinguishing agents. However, on environmental grounds, it would be desirable not to employ HALON flame suppressants.

In one embodiment non-halon flame suppressant is described in U.S. Pat. No. 5,425,886. The non-HALON flame suppressant disclosed therein contains mixture of inert, non-oxidizing, nitrogen, carbon monoxide, carbon dioxide gases, and water vapor.

In one embodiment the flame suppressant is a liquid that may be at atmospheric pressure or pressurised.

The liquid may be selected from at least one member of the group consisting of water, carbonated water, aqueous water-soluble salts (such as sodium bicarbonate, or metal phosphates), emulsion stabiliser salts (ammonium nitrate ammonium formate sodium nitrate, or ammonium acetate), aqueous solutions capable of forming foam, gels, or emulsions.

In one embodiment the liquid is water.

In one embodiment the liquid is one or more aqueous water-soluble salts.

The water may be additised. Additised water may contain at least one other additive selected from the group consisting of surfactants, dispersants, emulsifiers, foaming agents, antifreeze additives, and fire extinguisher chemicals (such as hydrofluorocarbons, chlorofluorocarbons, and alkylphosphates).

Emulsions formed when the fuel and aqueous liquid come into contact may be both macro- and micro-emulsions, although typically microemulsions are formed. The macro emulsions may be water-in-oil, or oil-in-water. Typically, the emulsion is a fuel emulsion formed by accidental rupture in most instances may still be capable of functioning as a fuel.

A micro emulsion is a stable, isotropic liquid mixture of oil, water and surfactant, frequently in combination with a cosurfactant. The aqueous, or “water” phase may contain salt(s) and/or other ingredients, and the “oil” phase may actually be a complex mixture of different hydrocarbons and olefins. Microemulsions form upon simple mixing of the components and do not require the high shear conditions generally used in the formation of ordinary emulsions. The basic types of macro emulsions are regular (oil dispersed in water, or o/w) or invert (water dispersed in oil, or w/o) or multiple emulsions, w/o/w (water-in-oil-in water) and o/w/o (oil-in-water-in-oil).

A marco emulsion may have droplet particle size of 100 nm or higher. A mircoemulsion may have droplets with a mean size of less than 100 nm, or less than 60 nm, and the droplets have thermodynamically stable.

Examples of macro emulsions are disclosed in International Publications WO 04/055138.

Examples of suitable surfactants for the micro- or marco-emulsions include an ionic (cationic or anionic) or non-ionic compound. The surfactants may be soluble or dispersible in the aqueous carrier fluid.

Suitable surfactant compounds include those with a hydrophilic lipophilic balance (HLB) ranging of 1 to 40, or 1 to 20, or 1 to 18, or 2 to 16, or 2.5 to 15. In different embodiments the HLB may be 11 to 14, or less than 10 such as 1 to 8, or 2.5 to 6. Those skilled in the art will appreciate that combinations of surfactants may be used with individual HLB values outside of these ranges, provided that the composition of a final surfactant blend is within these ranges. When the surfactant has an available acidic group, the surfactant may become the metal salt (or ammonia or amine salt) of the acidic group. When the metal is derived from an alkali metal base, examples may include alkali metal borates carbonates, bicarbonates.

Examples of these surfactants suitable for the invention are disclosed in McCutcheon's Emulsifiers and Detergents, 1993, North American & International Edition. Generic examples include alkanolamides, alkylarylsulphonates, amine oxides, poly(oxyalkylene) compounds, including block copolymers comprising alkylene oxide repeat units (e.g., Pluronic™), carboxylated alcohol ethoxylates, ethoxylated alcohols, ethoxylated alkyl phenols, ethoxylated amines and amides, ethoxylated fatty acids, ethoxylated fatty esters and oils, fatty esters, glycerol esters, glycol esters, imidazoline derivatives, phenates, lecithin and derivatives, lignin and derivatives, monoglycerides and derivatives, olefin sulphonates, phosphate esters and derivatives, propoxylated and ethoxylated fatty acids or alcohols or alkyl phenols, sorbitan derivatives, sucrose esters and derivatives, sulphates or alcohols or ethoxylated alcohols or fatty esters, polyisobutylene succinimide and derivatives.

In one embodiment the surfactant comprises polyesters as defined in column 2, line 44 to column 3, line 39 of U.S. Pat. No. 3,778,287. Examples of suitable polyester surfactants are prepared in U.S. Pat. No. 3,778,287 as disclosed in Polyester Examples A to F (including salts thereof).

In one embodiment the surfactant includes at least one of:
(a) at least one of an alkylamine ethoxylated surfactant that may be a mono- or a di-amine of the general formulae:

R—N(EₐH)—(CH₂)ₓ—N(E_{b}H)(E_{c}H) or R—N(EₐH) (E_{b}H)

wherein R equals straight or branched chained alkyl group, C₈ to C₃₀, or C₁₀ to C₂₄, and saturated or unsaturated, containing either 0, or 1, or 2 or 3 double bonds;

N=nitrogen atom;

E is an ethoxylate group, —CH₂—CH₂—O—

x is either 1, 2, or 3, and

a, b, c, is an integer from 0 to 20 such that: a+b+c=any value between 1 and 20, or between 1 and 14; and
(b) at least one PIBSA-derived material (with a polyisobutenylene chain in the molecular weight in the range of 200 to 5000) comprising:
(1) a PIBSA itself;
(2) a polyisobutenylene succinic acid, wherein this material may be prepared by reacting a PIBSA with water;
(3) a polyisobutenylene succinic acid-amine salt wherein this material may be prepared by reacting the polyisobutenylene succinic acid as described in (2) with either an alkyl amine (primary, secondary, or tertiary) or an ethanolamine and/or ethoxylated amine (A) described above and wherein this salt may be a fully neutralised or partially neutralised salt;
(4) a polyisobutenylene succinic aminoalkylester or ester-acid or amine salt thereof. This material may be prepared by reacting the PIBSA or polyisobutenylene succinic acid as described in (1) and (2) or ester thereof with a hydroxylamine or an alkanol amine like ethanolamine and/or ethoxylated amine (A) described above, or a dialkylaminoethanol (such as diethylaminoethanol or dimethylaminoethanol), wherein the salt may be a fully neutralised or partially neutralised salt;
(5) a succinimide or succinamide or amide-acid salt thereof derived by reacting PIBSA with an amine or poly amine;
(6) a succinic ester derived by reacting PIBSA with a polyol; or
(7) combinations thereof.

In one embodiment the surfactant is a hydrocarbyl substituted aryl sulphonic acid (or sulphonate) of an alkali metal, alkaline earth metal or mixtures thereof. The hydrocarbyl substituted aryl sulphonic acid may be synthetic or natural. The aryl group of the aryl sulphonic acid may be phenyl, tolyl or naphthyl. In one embodiment the hydrocarbyl substituted aryl sulphonic acid comprises alkyl substituted benzene sulphonic acid. In one embodiment the surfactants is a hydrocarbyl-substituted sulphonic acid, such as, polypropene benzenesulphonic acid, C₁₆-C₃₆ alkyl benzenesulphonic acid, and C₁₆-C₂₆ alkyl benzenesulphonic acid or mixtures thereof.

The hydrocarbyl (especially an alkyl) group typically contains 8 to 30, or 10 to 26, or 10 to 15 carbon atoms. In one embodiment the surfactant is a mixture of C₁₀ to C₁₅ alkylbenzene sulphonic acids. Examples of sulphonates include dodecyl and tridecyl benzenes or condensed naphthalenes or petroleum, sulphosuccinates and derivatives.

In one embodiment the surfactant is in the form of a neutral or overbased surfactant of a neutral or overbased surfactant typically salted with an alkali or alkaline earth metal. The alkali metal includes lithium, potassium or sodium; and the alkaline earth metal includes calcium or magnesium. In one embodiment the alkali metal is sodium. In one embodiment the alkaline earth metal is calcium.

In one embodiment the fuel may be additised with dispersants, surfactants, emulsifiers, or mixtures thereof. The surfactants may be the same as those discussed above relating to micro- and macro-emulsions. Dispersants for fuels are well known and include polyisobutylene succinimides (typically gasoline dispersants), or Mannich products of an alkylphenol reacted with an amine and an aldehyde (typically formaldehyde).

In one embodiment the fuel may be additised with dispersants, surfactants, emulsifiers, or mixtures thereof which may be water-soluble. Typically water-soluble dispersants, surfactants, or emulsifiers have a hydrophobic/lipophilic balance (HLB) of greater than 12, or greater than 12 to 40, or 20 to 30.

In one embodiment at least one surfactant with a high oil affinity may be present in the diesel fuel; and at least surfactant with a high water affinity may be present in the water of the flame suppressant.

In one embodiment a microemulsion (formed after rupture) may contain an aqueous phase containing polyolefin ethers, amides (oleyl diethanolamide, or diethanolamine soap of oleic acid), amines (such as ethoxylated amines or diethanolamine) or alcohols (such as ethylene glycols, ethoxylated alcohols, fatty alcohols) that are water-soluble. A more detailed description of emulsions containing oleyl diethanolamide diethanolamine soap of oleic acid 8-14, or diethanolamine is disclosed in U.S. Pat. No. 4,173,455.

In one embodiment the flame suppressant may also contain polar tert-butylstyrene copolymers manufactured by emulsion polymerisation. A more detailed description of these copolymers is provided in U.S. Pat. No. 3,846,091.

In one embodiment the flame suppressant may contain oxyalkylated surfactants, especially poly(alkylene ethers) or poly(oxyalkylenes). These surfactants are described in U.S. Pat. No. 3,613,372.

In one embodiment the flame suppressant may contain poly(oxyethylene) sorbitan monooleate. A more detailed description is given in U.S. Pat. No. 3,458,294.

In one embodiment the flame suppressant may also contain film forming additives, such as potassium acetate.

### INDUSTRIAL APPLICATION

The method of the invention may be suitable for a wide range of fuel tanks and storage containers.

The fuel tank may be suitable for use in an emergency vehicle, a military vehicle, an aircraft, a helicopter, a ship, a motor sports vehicle, a train, or an underground quarry vehicle.

In one embodiment the fuel tank is suitable for a military vehicle. Military vehicles include vehicles with two or more wheels, four or more wheels, and/or caterpillar tracks.

Emergency vehicles include ambulances, police vehicles or fire department vehicles.

Each of the documents referred to above is incorporated herein by reference. Except in the Examples, or where otherwise explicitly indicated, all numerical quantities in this description specifying amounts of materials, reaction conditions, molecular weights, number of carbon atoms, and the like, are to be understood as modified by the word “about.” Unless otherwise indicated, each chemical or composition referred to herein should be interpreted as being a commercial grade material which may contain the isomers, by-products, derivatives, and other such materials which are normally understood to be present in the commercial grade. However, the amount of each chemical component is presented exclusive of any solvent or diluent oil, which may be customarily present in the commercial material, unless otherwise indicated. It is to be understood that the upper and lower amount, range, and ratio limits set forth herein may be independently combined. Similarly, the ranges and amounts for each element of the invention may be used together with ranges or amounts for any of the other elements.

While the invention has been explained in relation to its preferred embodiments, it is to be understood that various modifications thereof will become apparent to those skilled in the art upon reading the specification. Therefore, it is to be understood that the invention disclosed herein is intended to cover such modifications as fall within the scope of the appended claims.

What is claimed is:

1. A method for improving the safety of a fuel tank comprising supplying to the fuel tank a fuel and a flame suppressant, wherein the fuel tank contains two or more compartments, at least one compartment containing fuel, and at least one compartment containing a flame suppressant, and wherein the compartment containing flame suppressant is either:
(i) located to the exterior of the fuel tank,
(ii) located within the interior of the fuel tank, or
(iii) mixtures thereof;
wherein upon rupturing the fuel tank and the compartment containing flame suppressant the flame suppressant is mixed or otherwise contacted with fuel from the fuel tank; and wherein the flame suppressant is a water-in-oil emulsion of a diesel fuel, wherein the diesel fuel is in the water-in-oil emulsion oil phase.

2. The method of claim 1, wherein the fuel tank contains two or more compartments, at least one compartment containing fuel, and at least one compartment containing an aqueous fluid which acts as a flame suppressant and wherein the compartment containing flame suppressant is located to the exterior of the fuel tank.

3. The method of claim 1, wherein the fuel tank contains two or more compartments, at least one compartment containing fuel, and at least one compartment containing flame suppressant, and wherein the compartment containing flame suppressant is located within the interior of the fuel tank.

4. The method of claim 1, wherein the fuel tank contains three or more compartments, at least one compartment containing fuel, and at least one compartments comprising flame suppressant, wherein at least one compartment containing flame suppressant is located to the exterior of the fuel tank, and wherein at least one compartment containing flame suppressant is located within the interior of the fuel tank.

5-16. (canceled)

17. The method of claim 1, wherein the fuel is additised with oil-soluble surfactants, dispersants or emulsifiers.

18. (canceled)

19. The method of claim 1, wherein the compartment containing flame suppressant and fuel tank are separate units connected with a pipeline with a one-way valve allowing flame suppressant to flow into the fuel tank.

20. The method of claim 1, wherein the fuel tank is a vehicle fuel tank.

21. The method of claim 20, wherein the vehicle is emergency vehicle, a military vehicle, an aircraft, a helicopter, a ship, a motor sports vehicle, a train, or an underground quarry vehicle.

22. The method of claim 21, wherein the vehicle is a military vehicle.

23. The method of claim 22, wherein the military vehicle has four or more wheels, or caterpillar tracks.

24. The method of claim 21, wherein the vehicle is an ambulance, a police vehicle or fire department vehicle.
